(19) United States
(12) Patent Application Publication
(10) Pub. No.: US 2007/0057136 A1
(43) Pub. Date: Mar. 15, 2007

(54) Standard and bracket support system

(76) Inventor: Tom Houlden, Los Angeles, CA (US)

Correspondence Address: Patrick F. Bright;BRIGHT & LORIG, P.C., Suite 3330, 633 W. 5th Street, Los Angeles, CA, 90071, US

(21) Appl. No.: 11/225,756

(22) Filed: Sep. 13, 2005

(51) Int. Cl. B42F 13/00

(52) U.S. Cl. 248/339

(57) ABSTRACT

A wall-mounted or free-standing standard and bracket supporting system allows for slideable height-wise positioning of various types of shelving structures, display fixtures and storage units along the standards, and to a wall paneling system that facilitates a broad range of wall covering that is easily modifiable and allows for a diversity of graphical display options.

The present invention relates to a standard and bracket support system for supporting various types of shelf brackets, hanging rods, storage units such as drawers or cabinets, hang bars, and the like, either as an installation attached to a wall or as a free-standing unit. The standard and bracket system is specifically designed to support removably affixed wall paneling to facilitate a broad range of display possibilities and wall covering designs that are rapidly modifiable and aesthetically pleasing.

### BACKGROUND OF THE INVENTION

Standard and bracket support systems must include a method of affixing the support structure to a wall or a method of supporting shelving and the like in a free-standing support unit. The present invention improves upon previous methods of affixing to a wall, resulting in a stronger support system that has a greater load-bearing capacity (e.g. than the support systems described in U.S. Pat. Nos. 5,388,796, 3,865,337, 2,703,692, and 4,421,289). The present invention is also an improvement over these and other support systems because it is capable of supporting a display in a free-standing unit and because it is designed with aesthetics in mind. The new standard and bracket system, when used to support the modular shelving and wall panel system herein described, allows great flexibility in designing displays (e.g. for retail) and allows for rapid modification of such displays. The present invention comprises graphical design elements to augment the aesthetically pleasing nature of the support and shelving system and to increase the variety of design options over known support and shelving systems. The system of the current invention also allows for support of a broad range of fixtures including shelving, shelving with racks, cabinets, wall paneling, and hang bars. In Goodman, et al., U.S. Pat. No. 5,063,715 (issued Nov. 12, 1991), a wall system is described comprising a means for mounting tiles to a rigid frame. However, this system is limited to equipment tiles and does not describe a support system for mounting aesthetic elements such as wall paneling, unlike the current invention.

### SUMMARY OF THE INVENTION

The present invention comprises a standard and shelf bracket system that allows for positioning of such brackets at any height along vertical standard rails. The standard of the system is comprised of a rectangular longitudinal channel with two front flanges, two rear flanges, and two pairs of fins that project inwardly within the channel from the front and rear faces of the channel. The longitudinal channel has three walls: two parallel side walls and a rear wall orthogonal to the side walls. The rear wall of the standard extends beyond the side walls of the channel creating two rear flanges. These rear flanges contain holes for attachment of the standard to wall by wall fasteners such as screw anchors.

The front flanges of the longitudinal channel project parallel to the rear wall of the channel both towards and away from the center of the channel. The front flanges project inwardly toward each other and the center of the channel, forming a longitudinal gap along the front of the standard. The purpose of this gap is to permit projection of the brackets supported by the standard through the gap, for the support of shelving and the like. The longitudinal gap formed by the inward extension of the front flanges is therefore preferably approximately the width of the brackets the standard is designed to support. The front flanges also project in a plane parallel to the rear wall of the channel, away from the center of the channel. These projections of the front flanges contain keyhole slots for hanging decorative or structural panels via a screw in the back of the panels and also facilitate leveling of the panel surfaces. A key feature of the standard of the present invention is the front flanges, as they allow easy and readily-modifiable attachment of wall paneling to the standards. Two pairs of fins within the longitudinal channel project inwardly from, and orthogonal to the front and rear faces of the channel. These fins provide support for brackets inserted into the standard at slots along the front face of the standard.

Two or more of the standards of the present invention are designed to support modifiable shelving when used in combination with two or more brackets of the present invention. These brackets comprise a first end that fits into the longitudinal opening of the standard's channel, an upper supporting system, and a means for securing the bracket within the channel when the brackets are in a load-bearing position. The brackets are pivotable inside the channel such that, when in a non-load-bearing position, the brackets may be moved to any vertical height within the channel. Upon pivoting to a load-bearing position, the brackets may be secured at any height within the channel. The standards include a plurality of openings formed in the face of the longitudinal channel to allow insertion and removal of the brackets at a plurality of points along the standard.

The standard and bracket system can support a wall covering system comprised of at least two standards and at least one wall panel. The wall panel is attached to the front flanges of said standards along its longitudinal edges by attachment means such as screws on the panels, inserted into keyholes in the standard. The longitudinal edges of the panel are formed to permit extension of the panels from the site of attachment along the front flanges over the inwardly-extending flanges, leaving the longitudinal opening of the channel exposed. End wall panels are designed to wrap around and hide the standard from view. The wall covering system of the present invention allows for a diversity of graphical display options, including use of electroluminscent tape, magnetic panels with magnet-backed removable prints, Velcro faced panels, Puck wall panels, and wall finishes such as veneer, plaster, wallpaper, and laminate.

This standard and bracket system can also support modular shelving. Standard fixtures such as shelves, drawers, cabinets, or hanging racks may rest on the brackets, or comprise a built-in hollow channel and securing means, e.g. pin-locking means, to slide over and cover the brackets. Modular shelving fixtures may be extruded poly(vinyl chloride) (PVC) or other shelving structures that allow for insert options in the center of the frame such as stainless materials, leather inserts, glass, trays, platforms for displays and/or storage.

In the case of the free-standing support system, the front and rear flanges are modified or eliminated to connect standards together and allow for stable support of an installation.

### BRIEF DESCRIPTION OF THE DRAWINGS

The invention can better be understood by reference to the following exemplary drawings in which:

Fig. WF-1 is a front elevation and cross-section view of a standard installation attached to a wall.

Fig. WF-2 is a front elevation and cross-section view of a standard and wall panel installation attached to a wall.

Fig. WF-3 is a front elevation and cross-section view of a standard, end panel(s) and shelf bracket installation attached to a wall.

Fig. WF-4 is a front elevation and cross-section view of a standard, end panel(s), shelf bracket, and shelf installation attached to a wall.

Fig. WF-5 is a front elevation and cross-section view of a standard, wall panel, shelf bracket, shelf and hanging bar installation attached to a wall.

Fig. WP-1 is a front elevation and detailed cross-section view of a wall panel.

Fig. WP-2 is a front elevation and detailed cross-section view of an end wall panel designed to wrap around and hide the standard it is attached to from view.

Fig. WP-3 is a front elevation and cross-section view of a middle wall panel.

Fig. EXT-1A is a cutaway view of a wall-mounted standard with attached panel and shelf bracket.

Fig. EXT-1 shows a front elevation, a plan elevation, and two cross-section views of a standard.

Fig. EXT-2 is a plan section through a free-standing double-sided extrusion.

Fig. EXT-3 is a plan section through a tri-extrusion used in free-standing triangle displays.

Fig. EXT-4 is a plan section through a free-standing four-sided extrusion.

Fig. SH-1 is a plan, front and end elevation of a shelf attached by shelf brackets to a wall.

Fig. SH-2 is a plan, front and end elevation of a twelve inch shelf frame attached by shelf brackets to a wall.

Fig. SH-3 is a plan, front and end elevation of a sixteen inch shelf frame with front hang hardware attached by shelf brackets to a wall.

Fig. HDWR-1 is a plan, front and end elevation of a shelf bracket and machined hex bar pin of the shelf bracket.

Fig. HDWR-2 is a front, plan, and section elevation of a hang bar unit.

Fig. FRS-1 is a front and plan elevation of a single free-standing quad unit utilizing two four-sided extrusions with center panel.

Fig. FRS-2 is a front and plan elevation of a single free-standing quad unit with two attached shelves utilizing two four-sided extrusions.

Fig. FRS-3 is a front and plan elevation of a single dressed free-standing quad unit with attached shelves and hang-bar units utilizing two four-sided extrusions.

Fig. FRS-4 is a front and plan elevation of a single dressed free-standing quad unit utilizing three four-sided extrusions.

Fig. FRS-5 is a plan elevation and detail of a free-standing triangle installation with base units utilizing three tri-extrusions.

Fig. FRS-5A is a plan elevation and detail of a free-standing triangle installation with base units utilizing three tri-extrusions with attached shelves and hang-bars.

Fig. D-1 shows a plan elevation and cross-sections through a wall-mounted standard with attached MDF panels and shelf bracket.

Fig. D2 is longitudinal cross-section of a wall-mounted standard with a shelf-bracket in slide and locked positions.

Fig. D-3 is a front elevation and cross-section of a wall-mounted standard with attached panels showing key hole for shelf bracket insertion.

Fig. D-4 is a plan elevation of a shelf corner, shelf and back panel assembly mounted to a wall.

### DETAILED DESCRIPTION OF THE PREFERRED EMBODIMENT

Fig WF-1 shows one embodiment of the standard of the system mounted to a wall. The standard may be formed from an appropriate material such as extruded aluminum. As shown in Figs. EXT-1 and EXT-1A, standard 1 comprises a longitudinal channel 35 formed by three walls: a back wall 15, and two side walls 16. The interior channel measurements of the back wall and side walls may be ⅝″ long. The standard 1 also has a longitudinal opening 36 defined by the inward extensions 18 of two front flanges 37 attached to the side walls 16 and extending inwardly in a plane parallel to that of the rear wall 15. The inward extension 18 of the front flanges 37, the back wall 15, and the side walls 16 define a modified T-shaped cross-sectional configuration for the channel 35.

The front flanges 37 and rear flanges 14 of the standard 1 are key features of the standard of the present invention. The front flanges 37 of standard 1 extend not only inwardly towards the center of the channel, 35, to form longitudinal gap 36, but also extend away from the center of the channel. These outward extensions 19 of the front flanges 37 are formed to attach to wall panels such as 2, 3, and 8 (see Figs. WP-1, WP-2, and WP-3). As shown in Fig. EXT-1A, keyholes 10 formed in these outward extensions 19 of the front flanges 37 are formed to secure wall panels such as 2, 3, and 8 via screws in the back of the panels (Figs. WP-1, WP-2, and WP-3). In one embodiment, screws may be attached ⅝″ from the edge of the panel. Fastening panels to the standard by this means allows for rapid and easy modifiability of wall paneling display. The outward extensions 19 of front flanges 37 preferably extend ½″ beyond the side walls 16, and front flanges 37 are preferably 13/16″ long overall. The standard's rear flanges 14 are an extension of rear wall 15. These rear flanges 14 contain holes 11 for attachment of the standard to a wall, such as drywall or plywood substrate, by fastening means, such as by number 6 screws, or any gauge screw as required for the substrate type. In one embodiment of the invention, standards are screwed to a wall lined with ¾″ board material for strength and plumb. The rear flanges 14 extend 1 1/16″ beyond the side walls 16, making the overall length of the rear wall of the channel with the rear flange extensions 3″ long in this embodiment. When the standard 1 is fastened to the wall, the rear flanges 14 and rear wall 15 bear firmly against the wall. This allows support for the standard 1 and strong attachment to the wall, leaving the channel free from holes and screws, and the interior of the channel smooth for receipt of shelving brackets such as shelving bracket 5. The cavity 43 (Fig. EXT-1A and Fig. EXT-1) formed by the separation between the front and rear flanges allows for concealment of hanging hardware between the wall and the fixtures attached to the support system. In one embodiment of the invention, this cavity 43 may be ⅝″ wide.

The interior channel of the standard 35 includes two pairs of fins, 13 and 17, that project orthogonally from the rear wall 15 of the channel, and orthogonally from the inward extensions 18 of the front flanges 37, respectively. These fins are formed to be gripped by the machined hex bar 26 of shelving bracket 5 shown in Fig. HDWR-1 when shelving bracket 5 is moved to a locked position as shown in Fig. D-2.

The standard 1 can be used in a support system with one or more brackets 5 as shown in Fig. WF-3. The bracket 5 comprises two ends as shown in Fig. HDWR-1. As can be seen in Fig. D-2, a first end 38 of bracket 5 has a flat rear edge which lies against the rear wall 15 of the standard 1 when the bracket 5 is pivoted into a locked position. The first end 38 also contains a machined hex bar 26 (Fig. D-2) for gripping the fins 13 and 17 (Fig. EXT-1) of standard 1. The hex bar 26 fits into the standard 1 through a hole 12 in the front face of standard 1, as shown in Fig. EXT-1. A matching hole is cut away from a wall panel 2, 3, or 4 as shown in Figs. WP-1, WP-2, and WP-3 respectively to allow for insertion of the shelving bracket 5 into the standard 1. A second end of the bracket 28, as shown in Fig EXT-1A, comprises an upper supporting surface along at least a portion of its length. The width of end 28 may be approximately the same as the width of longitudinal gap 36 of the standard 1. The machined hex bar 26 can grip fins 13 and 17 (Fig. EXT-1). The machined hex bar 26 is formed and shaped to allow for slideble positioning of the shelf bracket within the standard when the bracket is in slide position as shown in Fig. D-1. When the shelf bracket is rotated to a locked position, the machined hex bar 26 engages fins 13 and 17, gripping the fins firmly and securing the bracket 5 within the standard. Machined hex bar 26 can grip fins 13 and 17 (Fig. EXT-1) at any point longitudinally along channel 35 of standard 1. The bracket 5 may thus be slid to any height along the longitudinal channel 35 and secured by pivoting bracket 5 to a locked position as shown in Fig. D-2.

In one embodiment of the support system, two or more standards 1 support at least one wall panel, as shown in Fig. WF-2. The wall panel, such as 2 or 3, is attached along its longitudinal edges to the front flanges 37 of the standard 1. In one embodiment, panels are attached by readily modifiable attachment means such as by hooking screws attached to the longitudinal edges of the wall panel into the keyholes 10 formed into the front flanges 37 of standard 1 (Fig. EXT-1A). Three types of wall paneling—back wall panels, middle wall panels and end wall panels—are shown to depict examples of wall paneling as described by the current invention (Fig WP 1-3). A back wall panel 2 covers a relatively large display area between either two standards mounted to a wall or two free-standing extrusions. In one embodiment, standards may be mounted 48″ apart as shown in Fig. WF-1, and wall panels may have a height of 88″ and a width of 47 11/16″ as shown in Fig. WP-1. Holes in the edges of the panel formed for insertion of brackets through the wall panels may be formed 29 5/16″ from the top and bottom of the wall panel. As shown in Fig. D-3, a half-keyhole cut-out may be 3/16″ wide and ½″ long such that the keyhole opening 4 comprised of the two half-keyhole cut-outs in two wall panels and the longitudinal gap 36 between two wall panels may be ⅝″ wide. The keyhole 4 formed between two wall panels is thus the same width as the channel gap 35 between two side walls 16 of a standard 1. The longitudinal edges 39 of a back panel 2 may be thinner than the rest of the panel so that the back panel 2 lies flat against the standard when hooked via screws to the standard (Fig. WP-1). In one embodiment of the invention, the panel may be ⅝″ thick overall and its longitudinal edges may be ½″. The thinner edges may be ⅞″ wide in this embodiment, and are thus long enough to cover the front flanges 37 of the standard 1, which may be 13/16″ wide as shown in Fig. EXT-1. The width of the thinner longitudinal edge 39 is large enough to cover the front flanges of the standard, but not so wide as to obstruct longitudinal gap 36, as shown in Fig. WF-3. One back panel 2 may be used with one or more end panels 3, to cover the standards 1 from view as shown in Fig. WF-2. As shown in Fig. WP-2, an end panel 3 has a thicker longitudinal edge 40 that wraps around the standard. In one embodiment, this thicker longitudinal edge may be 1¼″ deep and ⅝″ wide. A middle wall panel 8 has a relatively narrow width as shown in Fig. WP-3. In one embodiment, this width may be 2 13/16″. This middle wall panel allows for two standards and brackets to be positioned side by side allowing for horizontally aligned shelves. Without this middle wall panel, adjacent shelves would have to be staggered along a central standard, resting above and below each other instead of side by side.

Panels may be made from a variety of materials including, but not limited to, compressed board, plywood or foam, though in the preferred embodiment, the panel is a medium density fiberboard (MDF) panel. The back, middle and end wall panels substantially cover the standards, giving the support system a clean, finished look, as seen in Fig. WF-5.

Wall panels hide wiring or other infrastructure behind the panel and between the front and rear flanges of the standards which also ensures a clean installation appearance. Panels may be covered with any of a variety of surface treatments to create different looks and feels. Wall paneling decorative options include, but are not limited to acetates or printable transparencies, magnetic panels with magnet-backed removable prints, Velcro-faced panels, Puck wall panels, low-voltage electroluminescent tape, and a variety of wall finishes, including veneer, plaster, and laminate. The variety of possible paneling and finishes for the wall paneling enhance options for visual differentiation and branding.

The standard and bracket support system can support modular shelving comprised of one or more standards 1 as depicted in Fig. WF-4, one or more brackets 5, and additional fixtures that rest on said brackets or comprise a built-in hollow channel and pin-locking means to slide over and cover said brackets, such as a shelf 6, or hang bars 7 (Fig. WF-5). Fig. D-4 shows a preferred embodiment of a shelf attached to a standard and bracket support system. A shelf may be solid or may include a frame 24 and insert panel 23 made of, e.g., glass, leather, stainless steel or other materials. In the case of a shelf with an insert panel, the support for the panel, 34, lies below the insert. A standard shelf may be 49¾″ long as shown in Fig. SH-1, but shelving may be any length or width. Fig. SH-2 shows a shelf frame that may be 12″ in width, and Fig. SH-3 depicts a shelf frame that may be 16″ in width. Shelves may also include additional elements, such as the hang bars 25 shown in Fig. SH-3 or brackets may support larger structures such as cabinets (not shown). Shelves may contain built-in hollow channels which slip over shelf brackets 5 and are secured in place via a pin passed through hole 27 (Fig. HDWR-1) in shelf bracket 5. Another type of shelving fixture, the hang bar, is shown in Fig. HDWR-2. Two shelving brackets 5 support a tube to create the hang bar unit. In one embodiment, the brackets may be formed from aluminum ⅜″ wide and the tube may be an aluminum tube, about 1.5″ in diameter.

This support system can also support installations in a free-standing unit. The extrusions for these free-standing units are comprised of two or more attached standards. A double-sided extrusion is shown in Fig. EXT-2. There, two standards face opposite directions and are connected by means of the outward extensions 19 of front flanges 37 and side pieces 41 which run parallel to side walls 16 of the standards. Rear flanges 14 are absent in this double-sided extrusion, as they are not needed for affixing to a wall. In one embodiment, the double-sided extrusion is 1½″ in width and 3″ long.

Another stand-alone fixture is the tri-extrusion depicted in Fig. EXT-3. Five standard units form an irregular heptagonal extrusion. A group of two and three standards are joined to one another at the intersection of the side walls 16 and the rear walls 15. The two and three standard groups are joined by angled rear flanges 14, which in one embodiment may be ¼″ long. The tri-extrusion shown in Fig. EXT-3 can be used in a triangle display as shown in Figs. FRS-5 and FRS-5A. A four-sided extrusion of the present invention is shown in Fig. EXT-4. Similar to the double-sided extrusion, the outward extensions 19 of the front flanges 37 of four standards are joined to one another by means of two orthogonal side walls, 42, which run parallel to the side walls 16 of the standards. These orthogonal side walls 42 may be ¾″ long in one embodiment, and front flanges 37 may be ⅝″ long. In many embodiments, the longitudinal opening 36 in the standard 1 may be ¼″ wide.

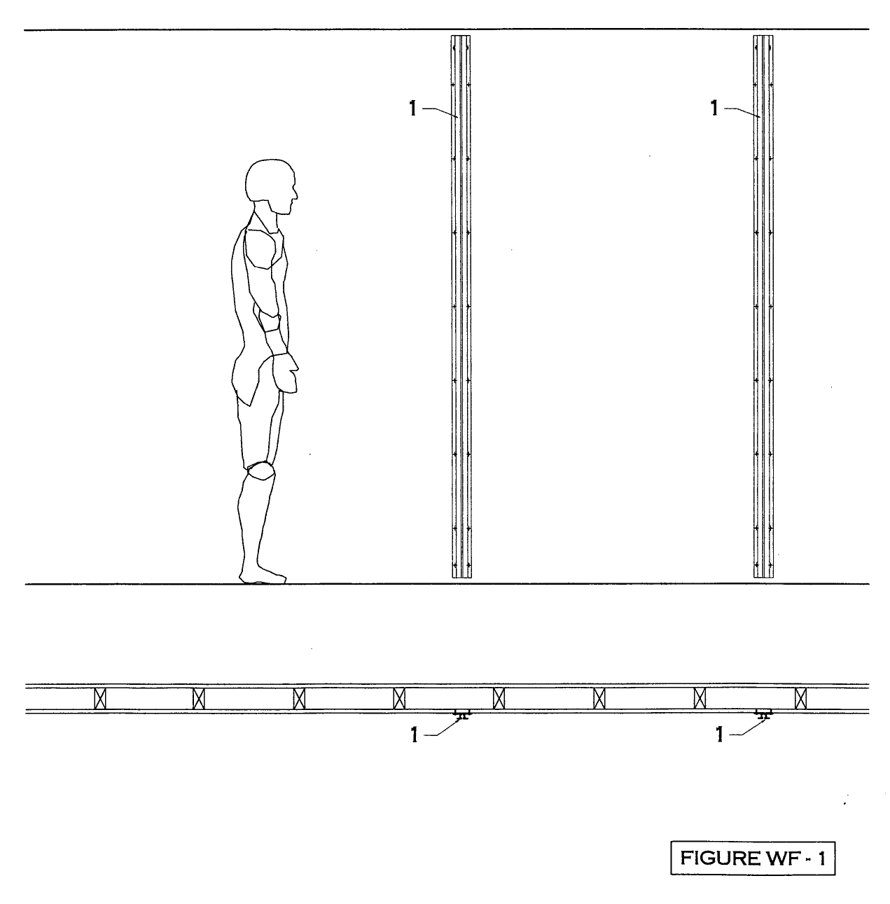

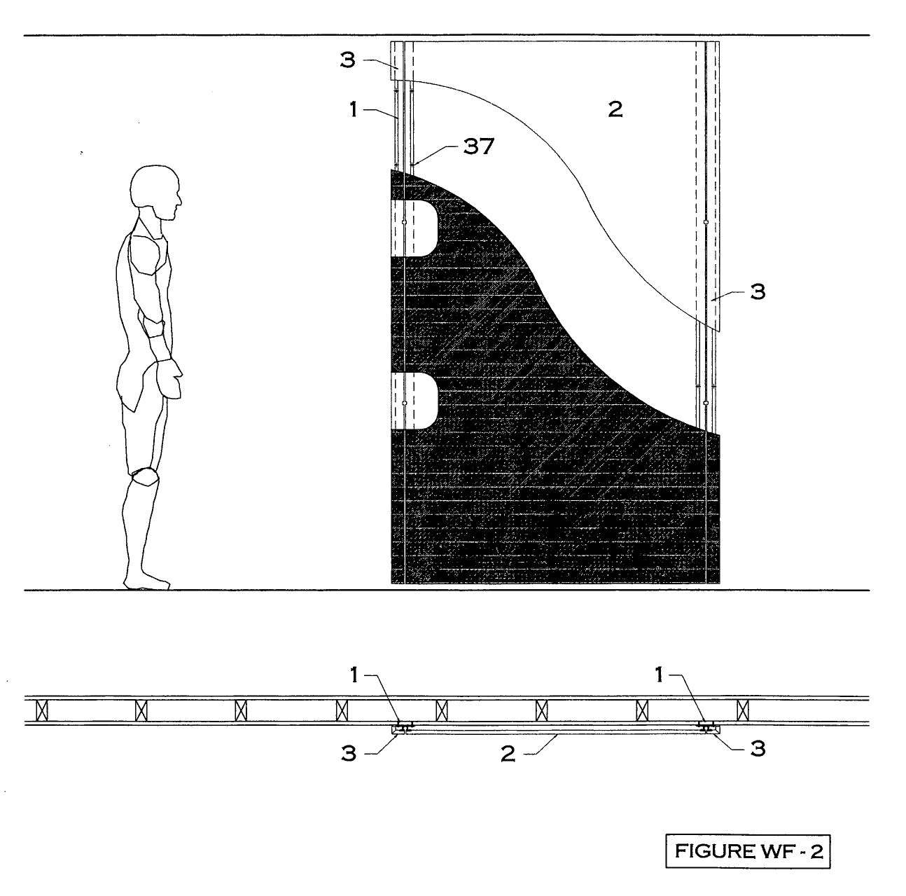

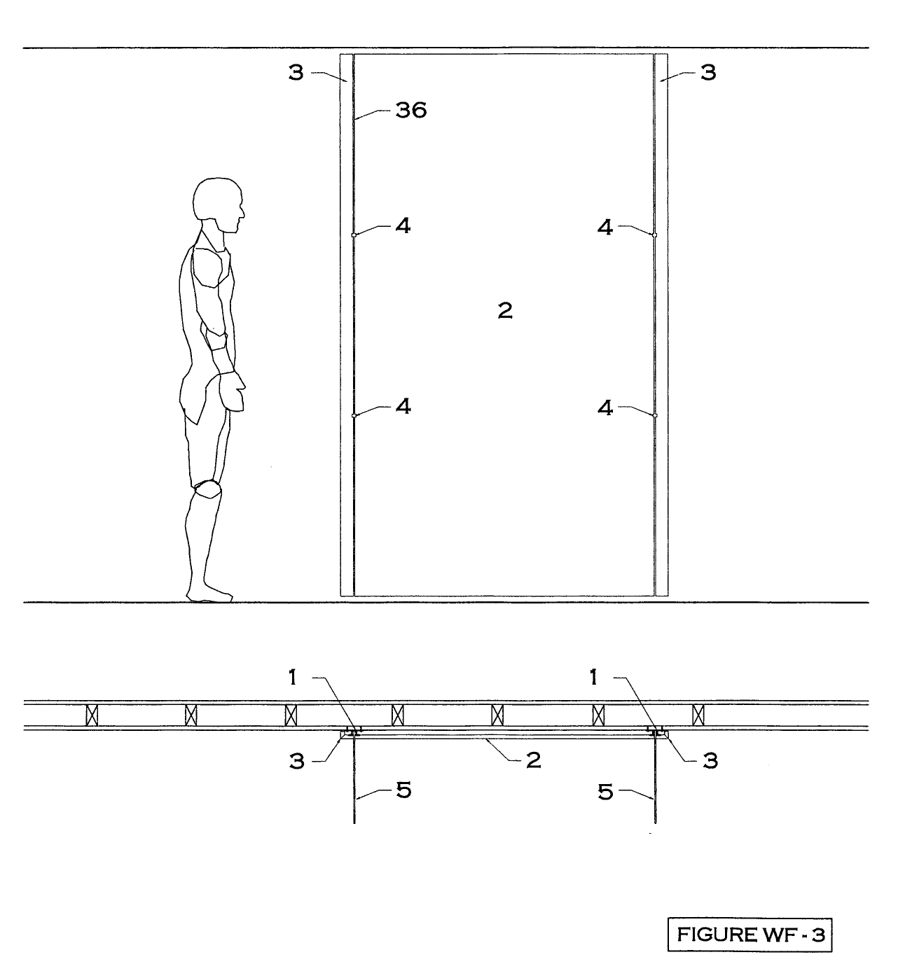

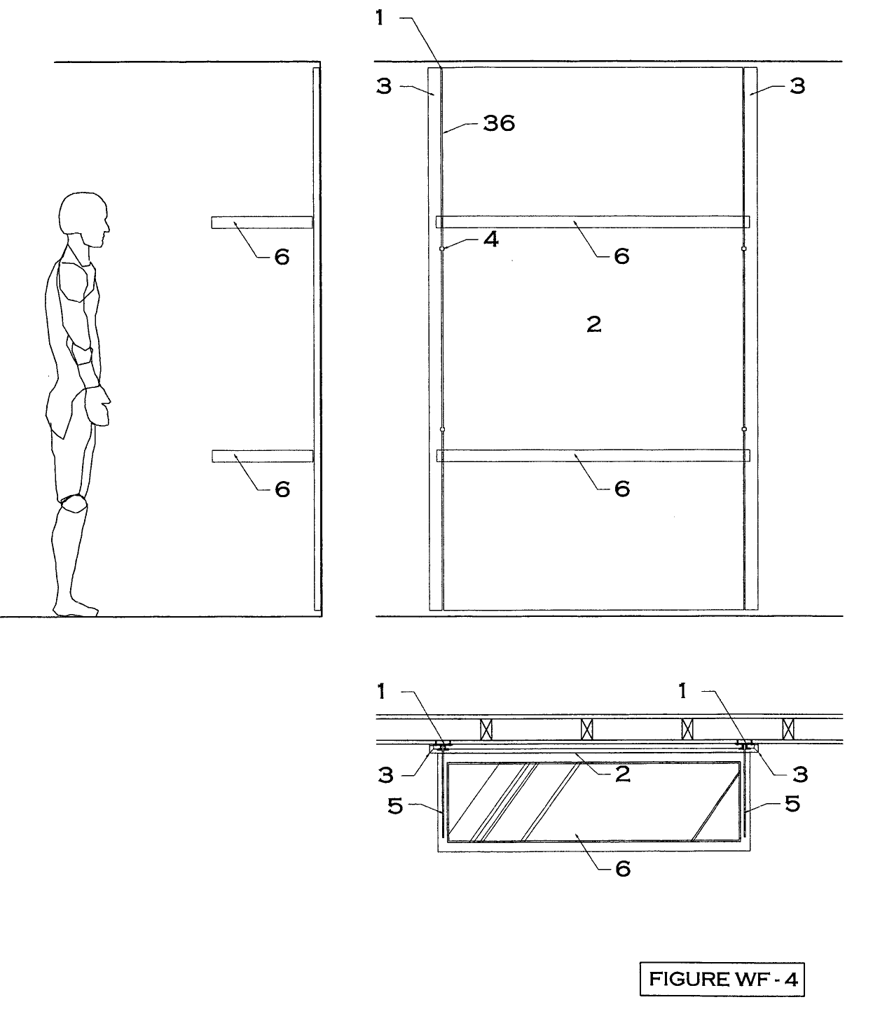

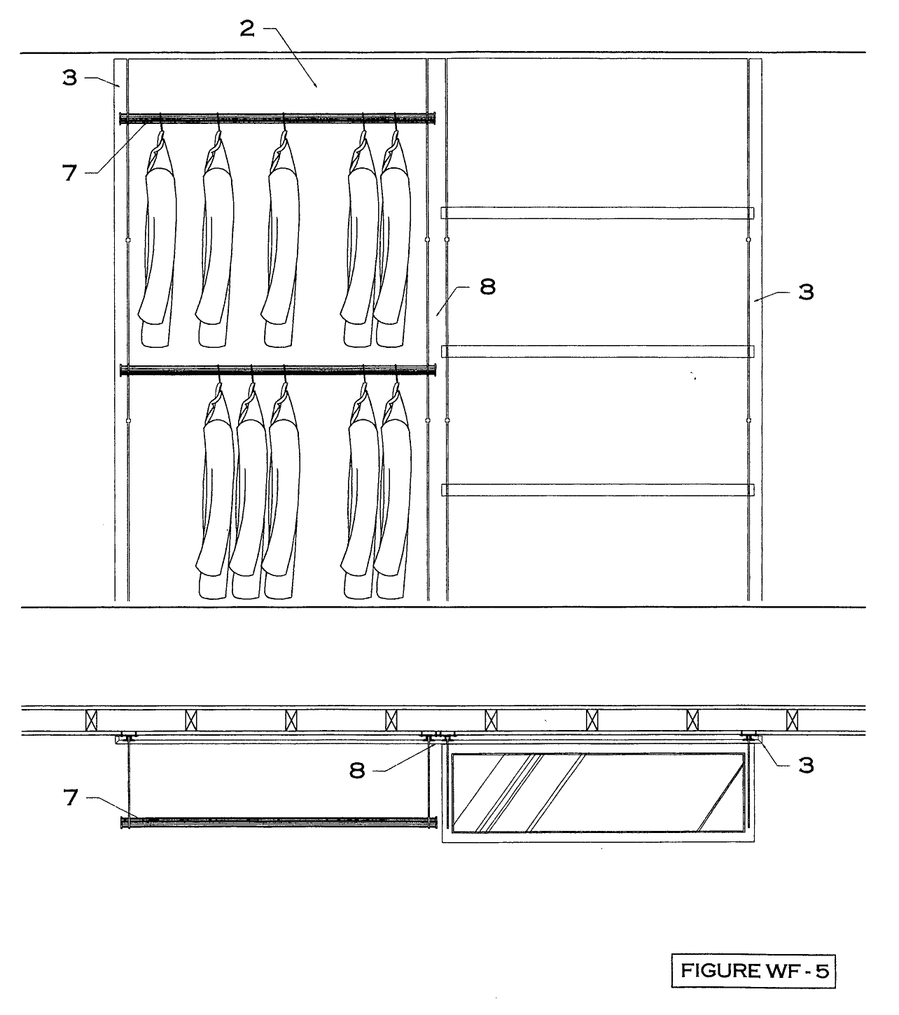

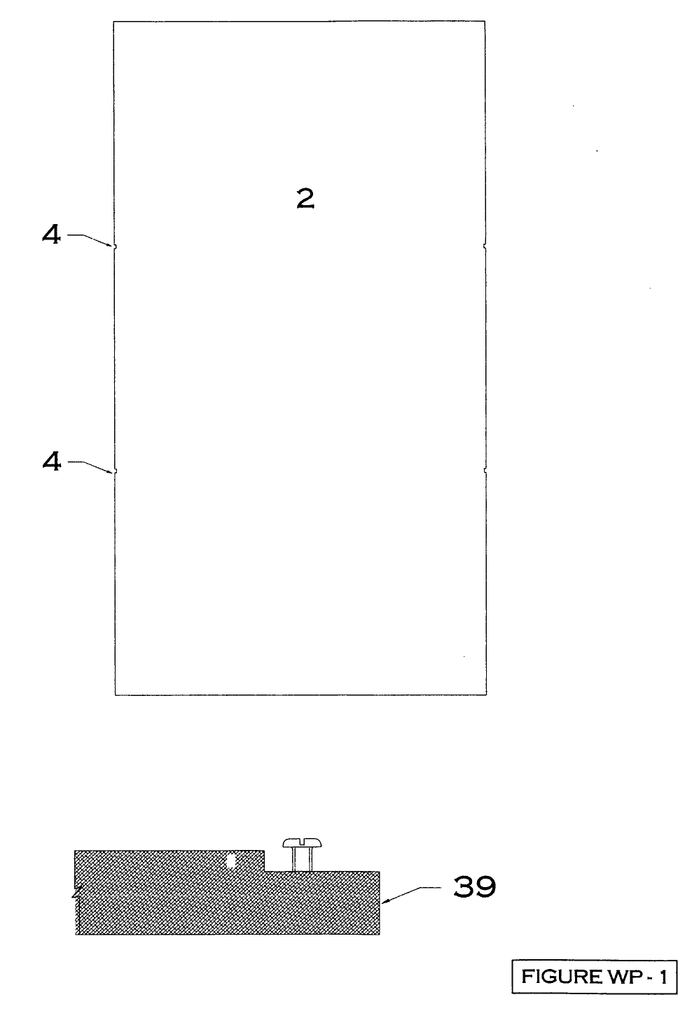

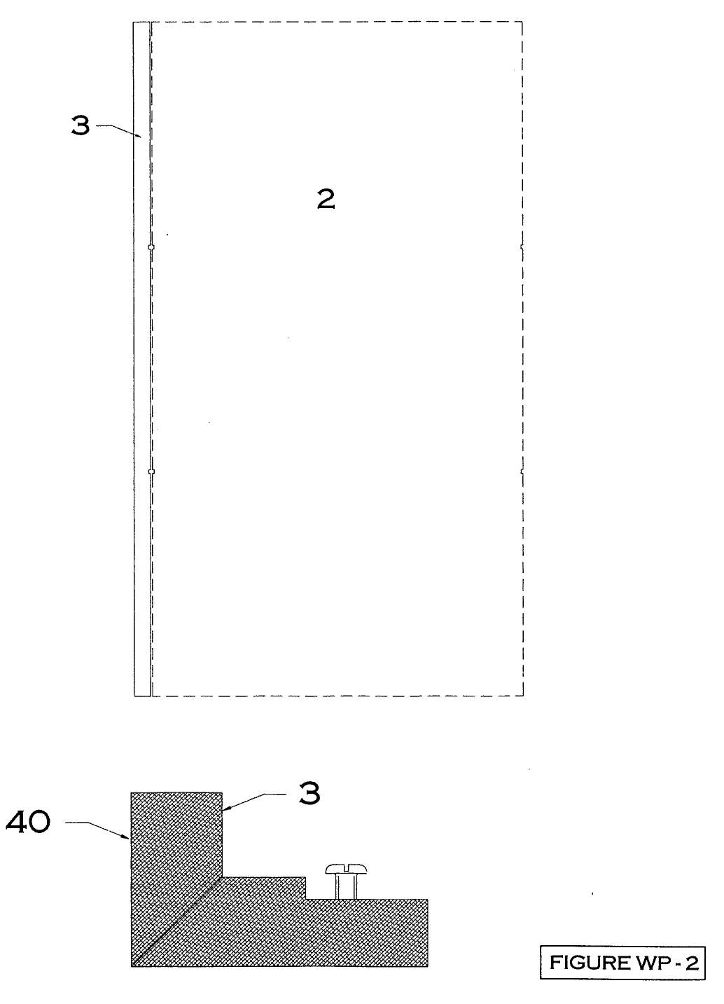

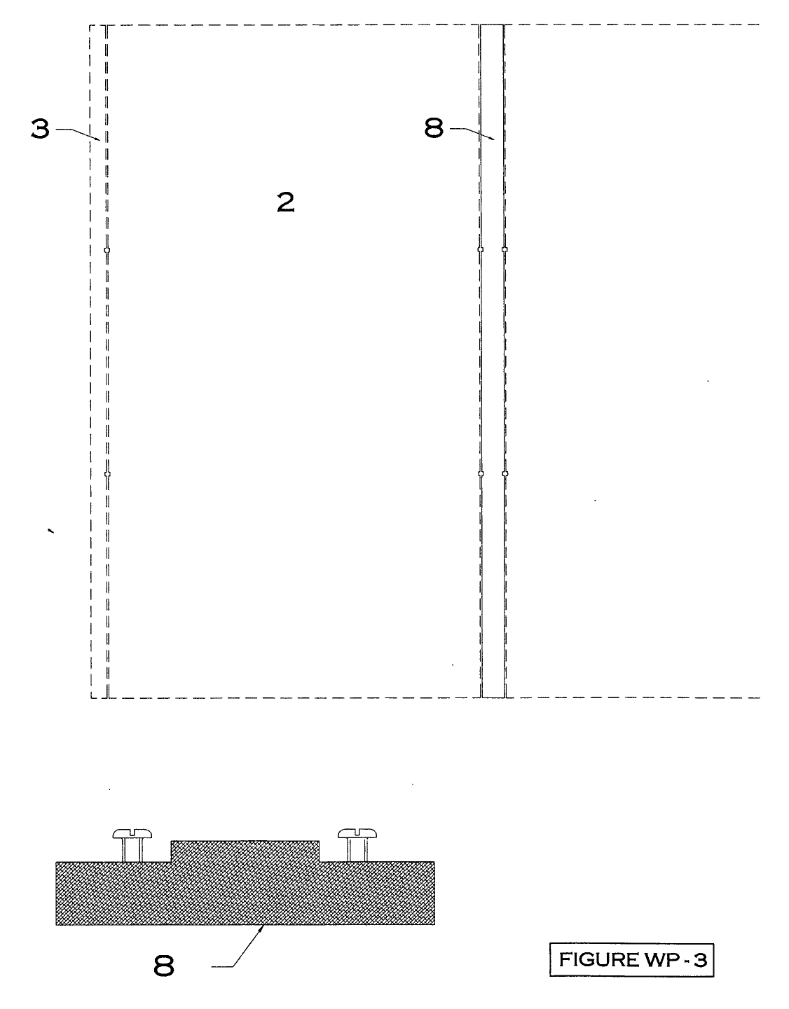

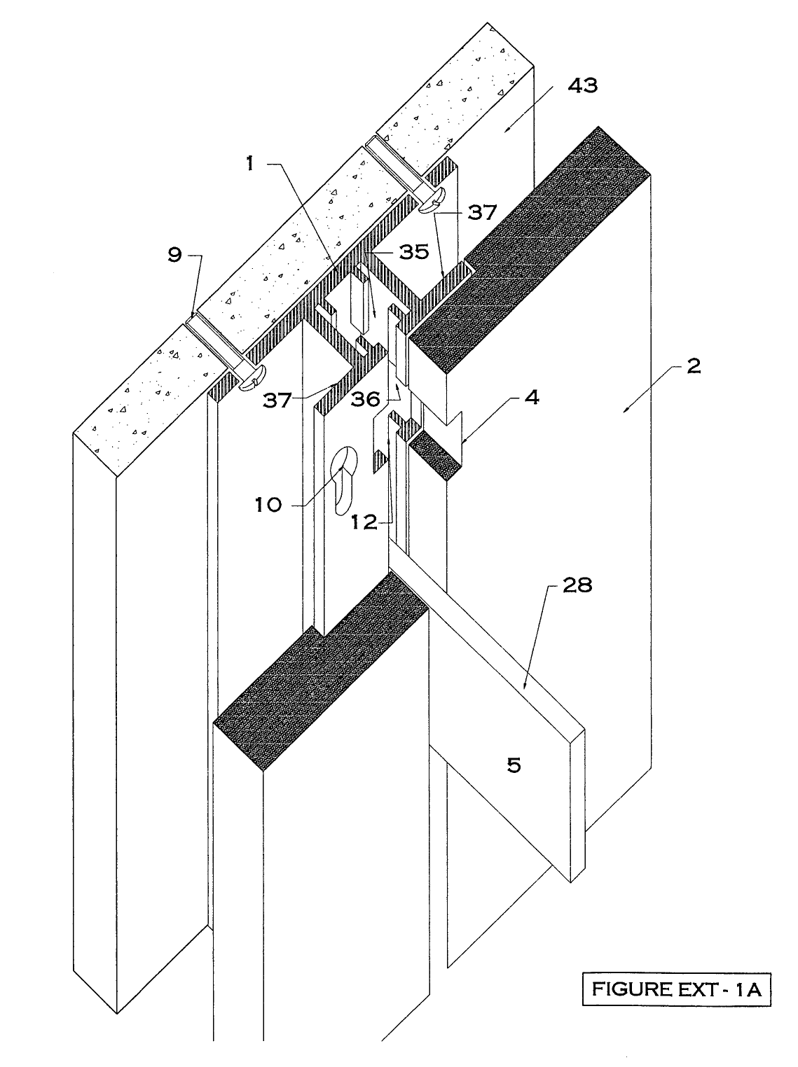

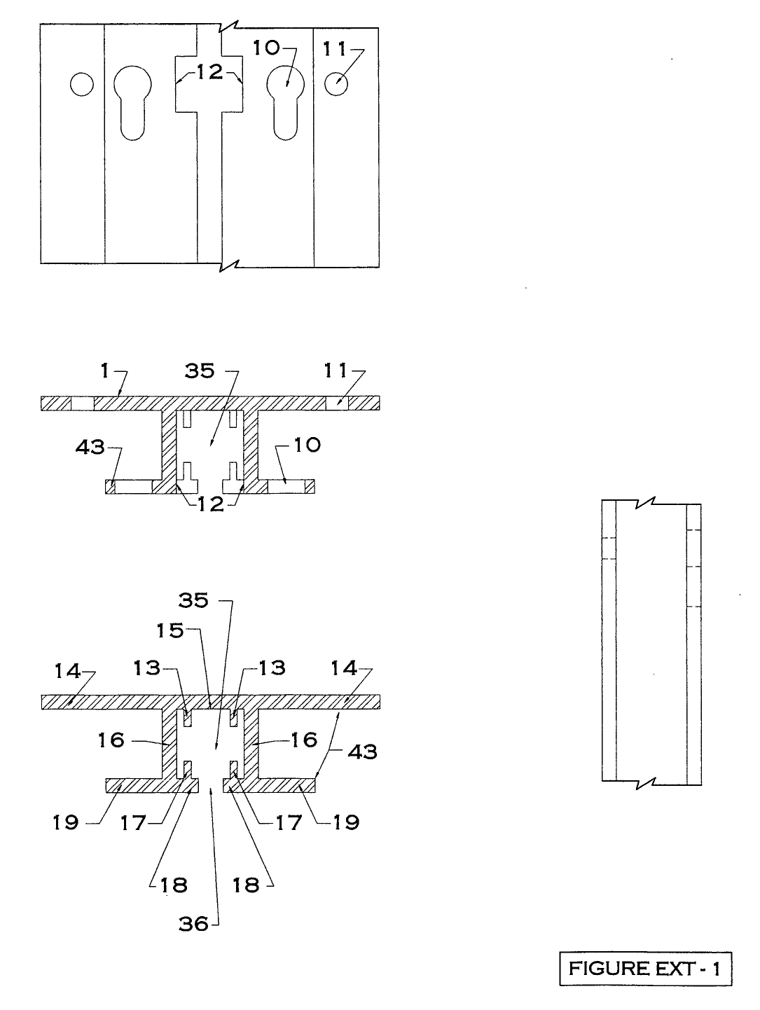

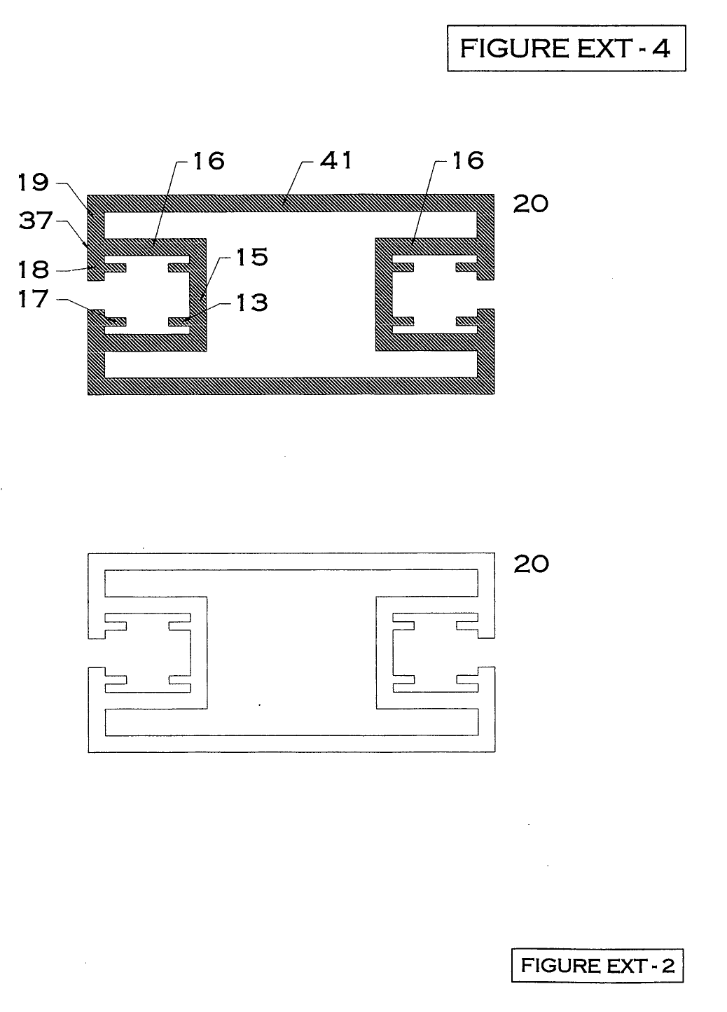

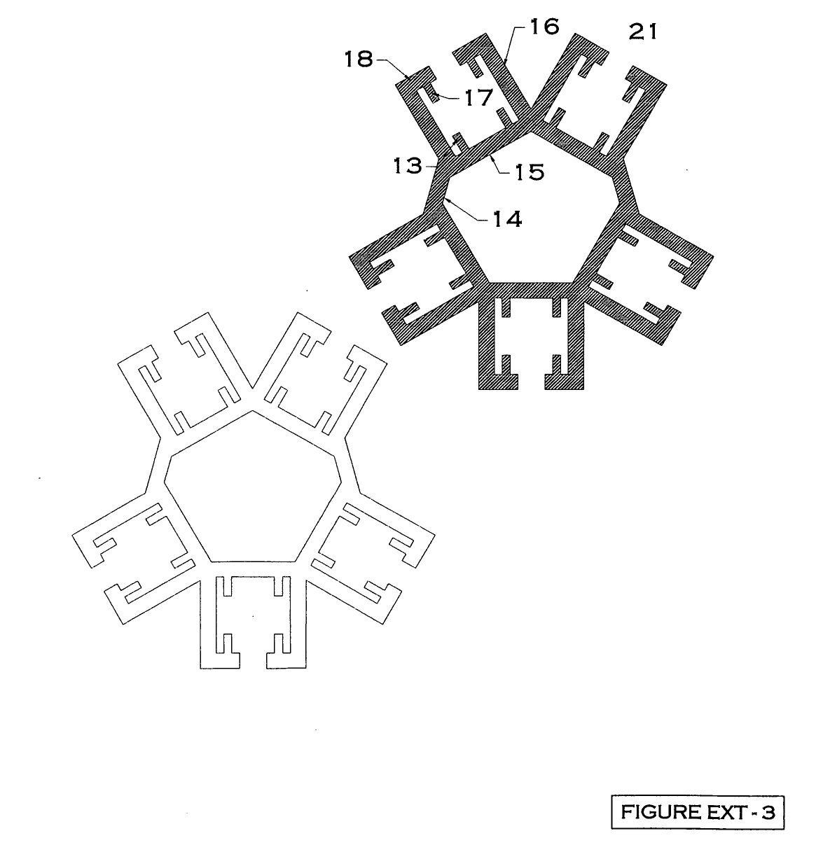

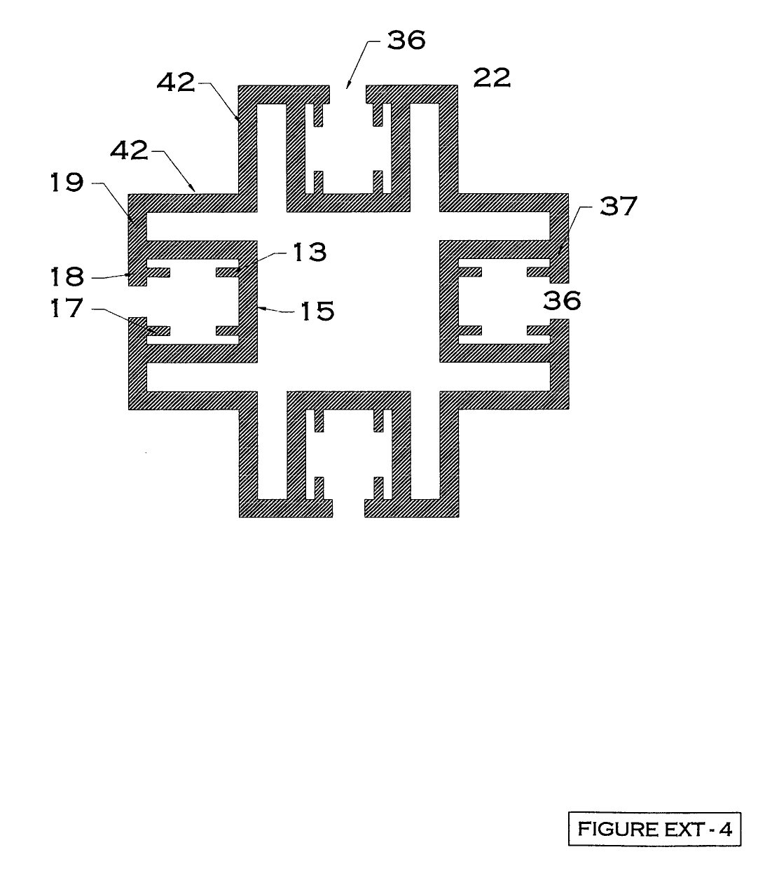

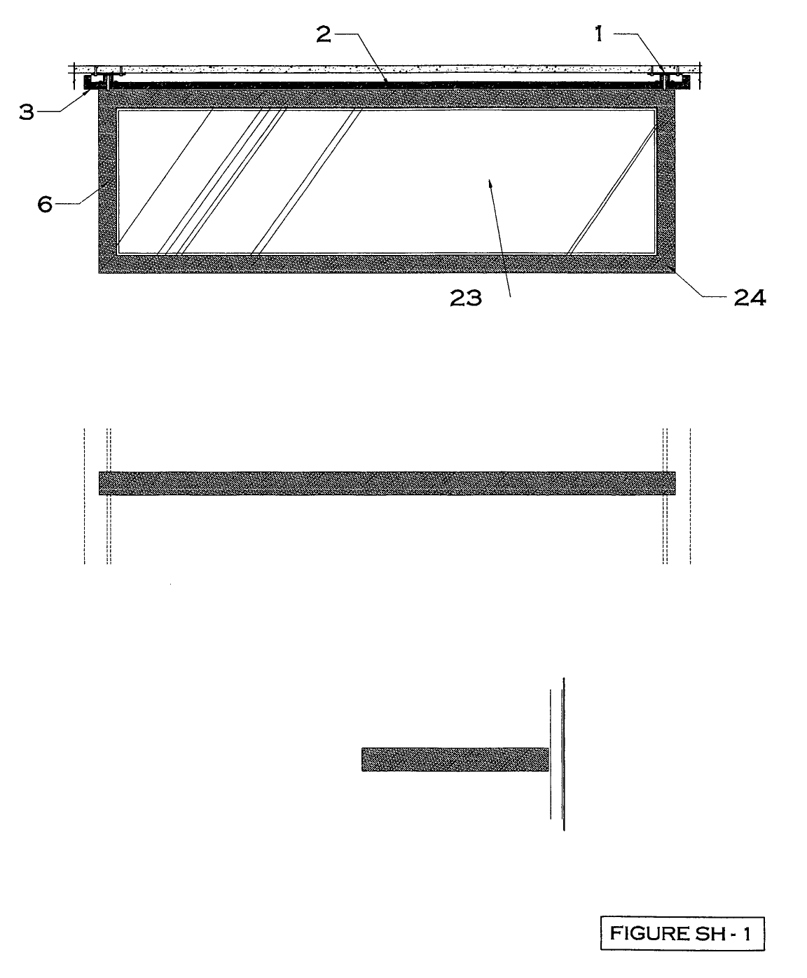

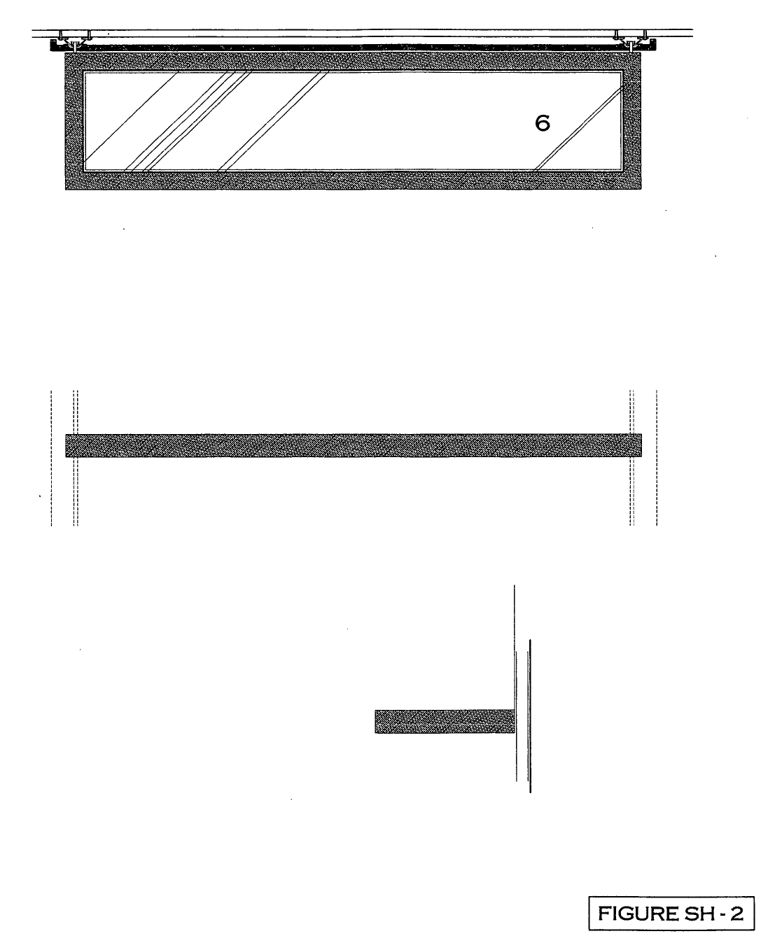

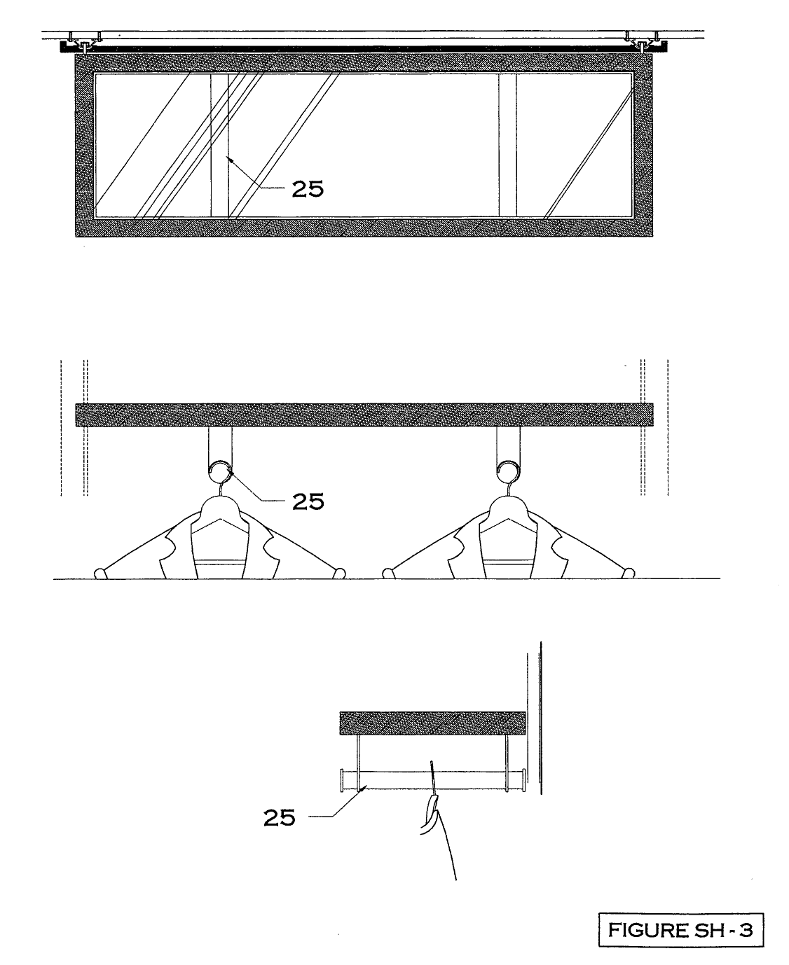

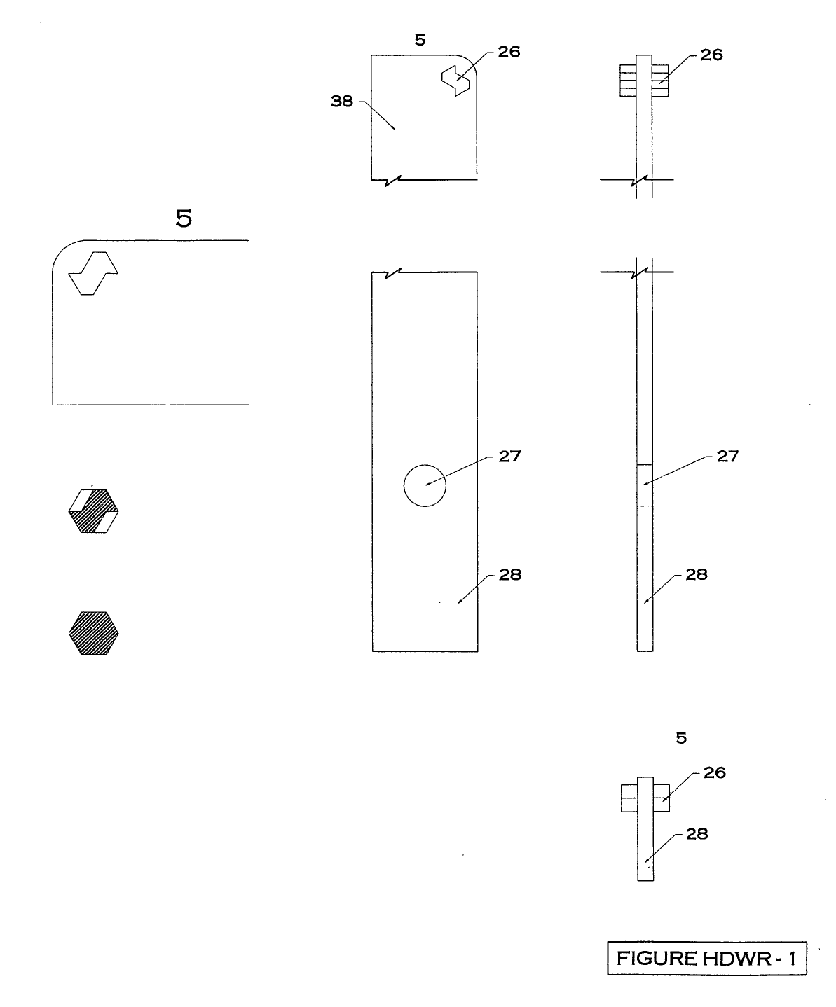

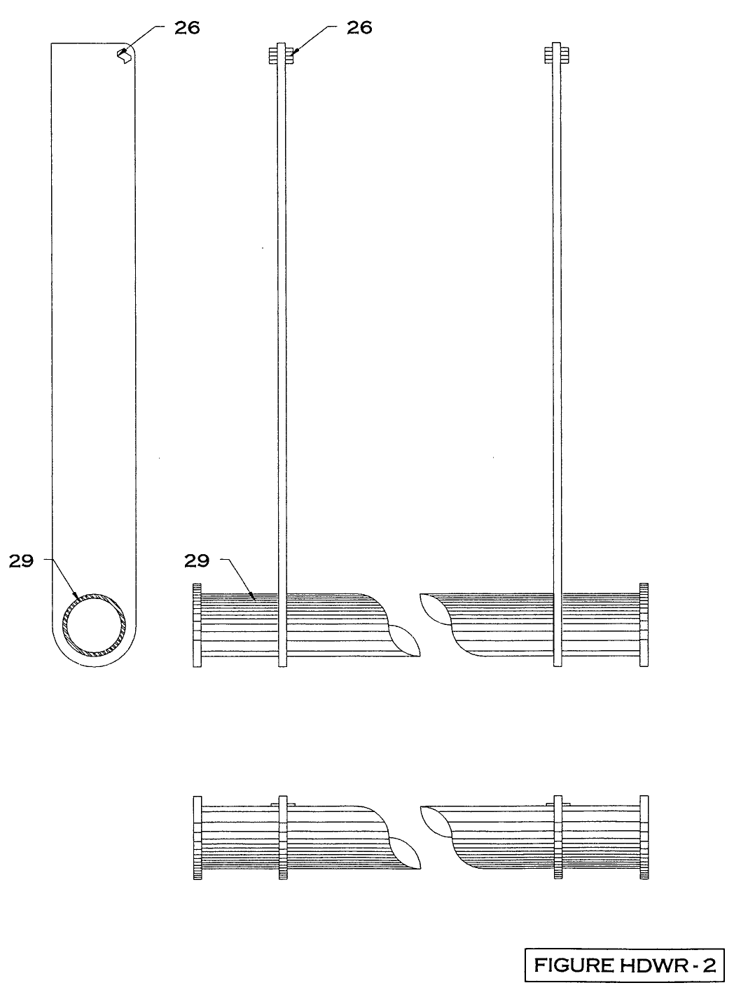

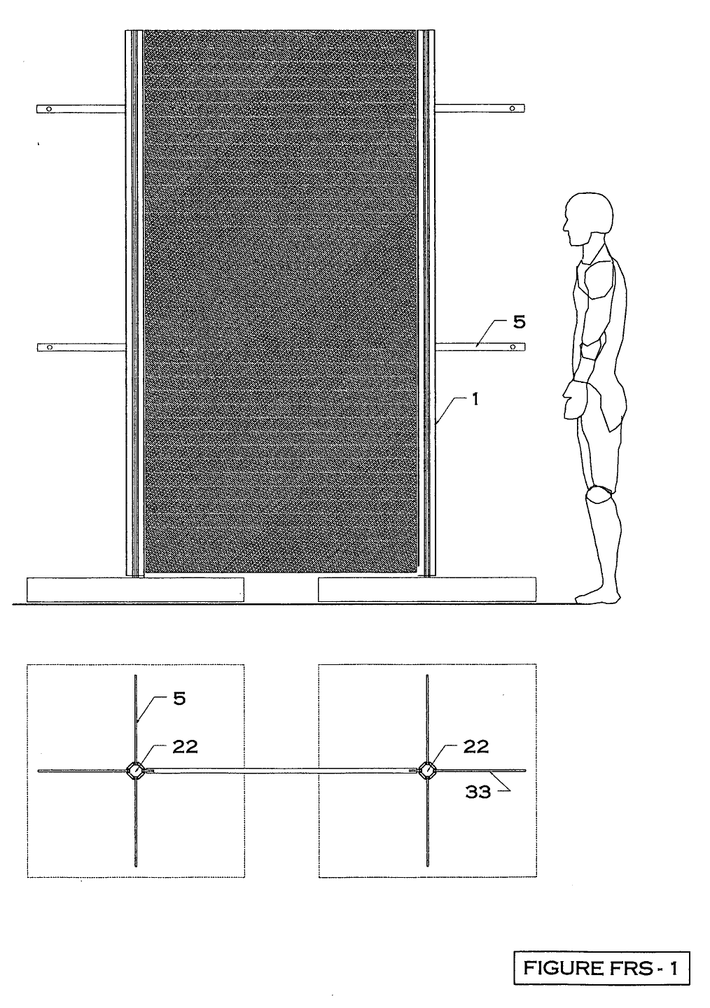

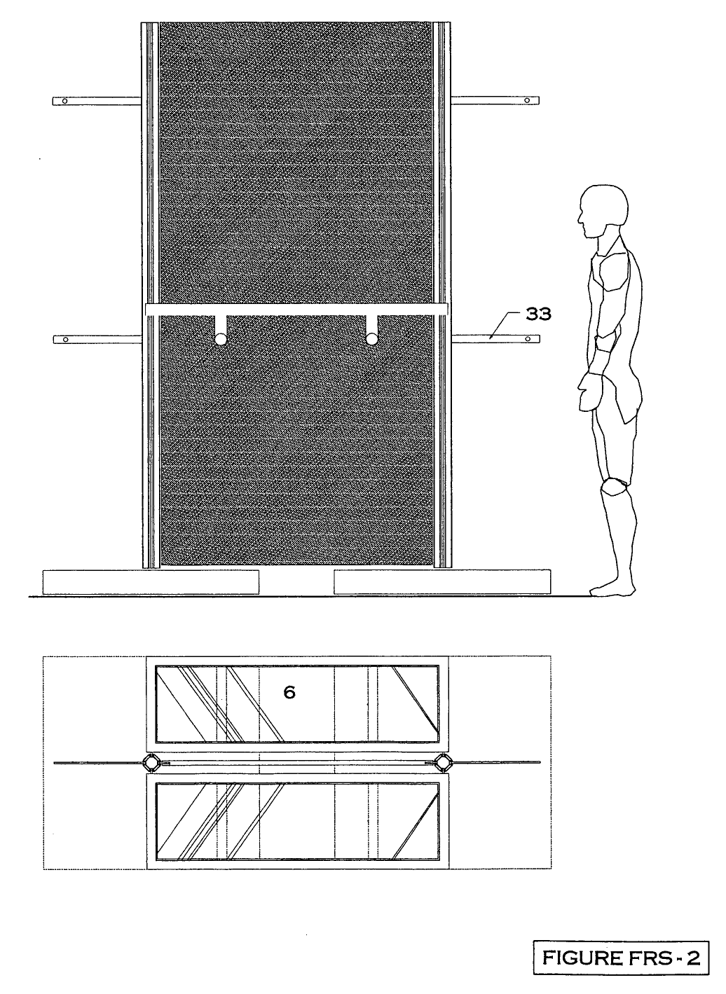

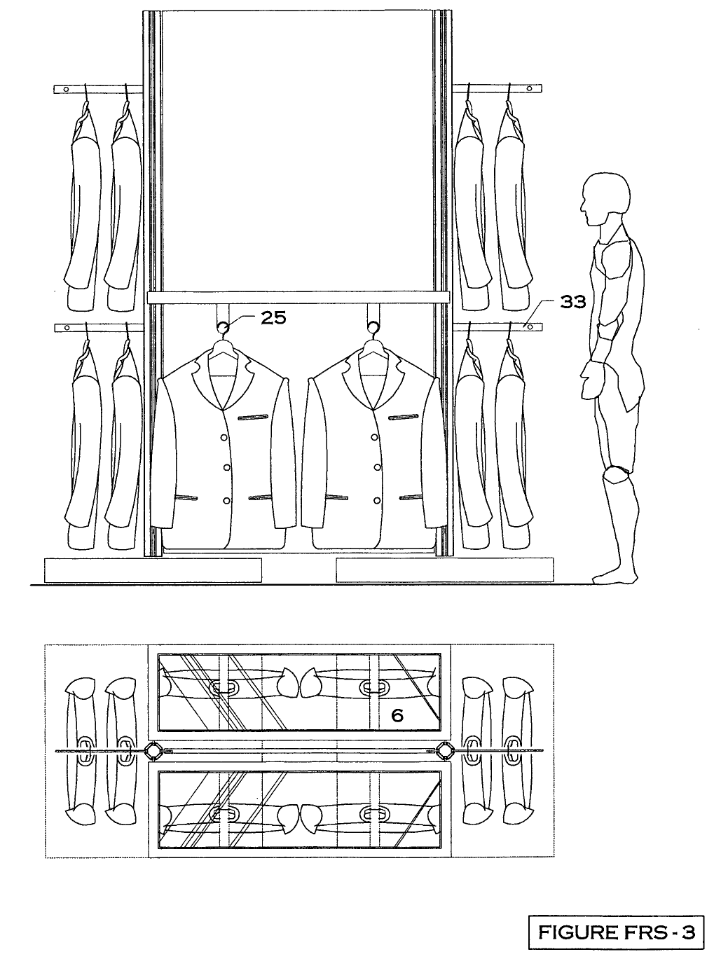

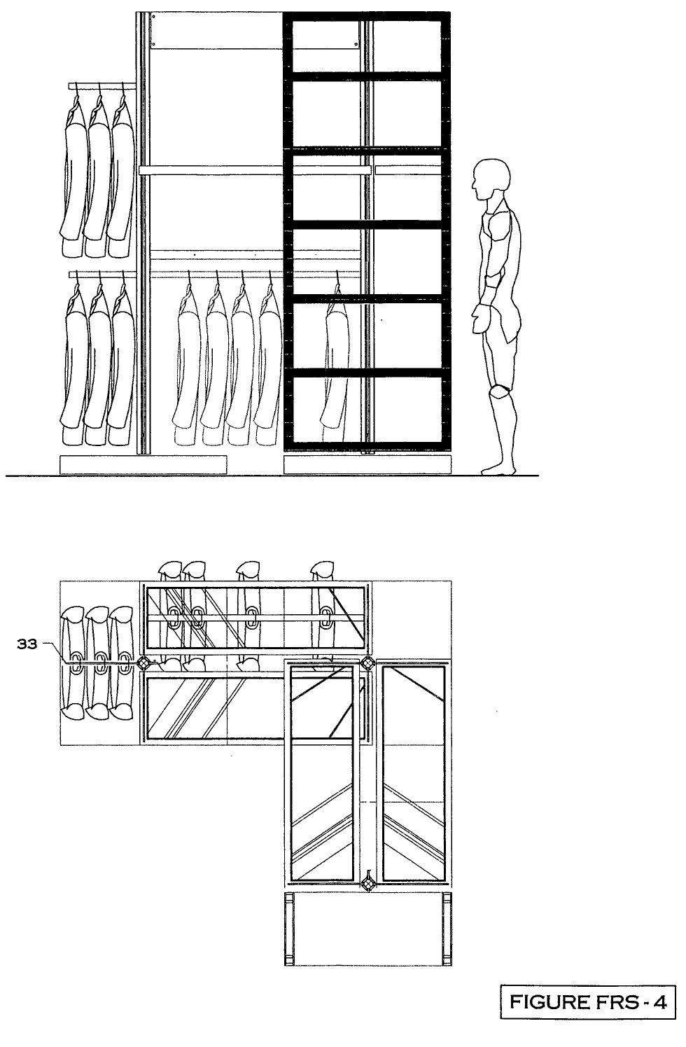

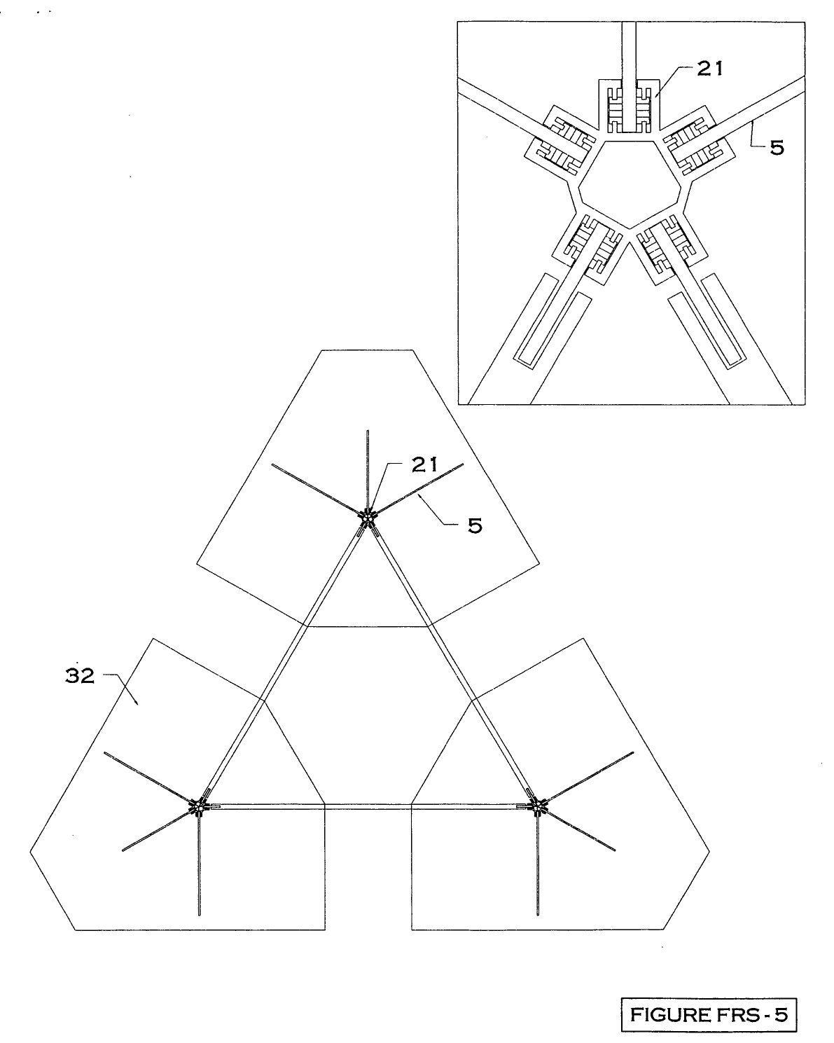

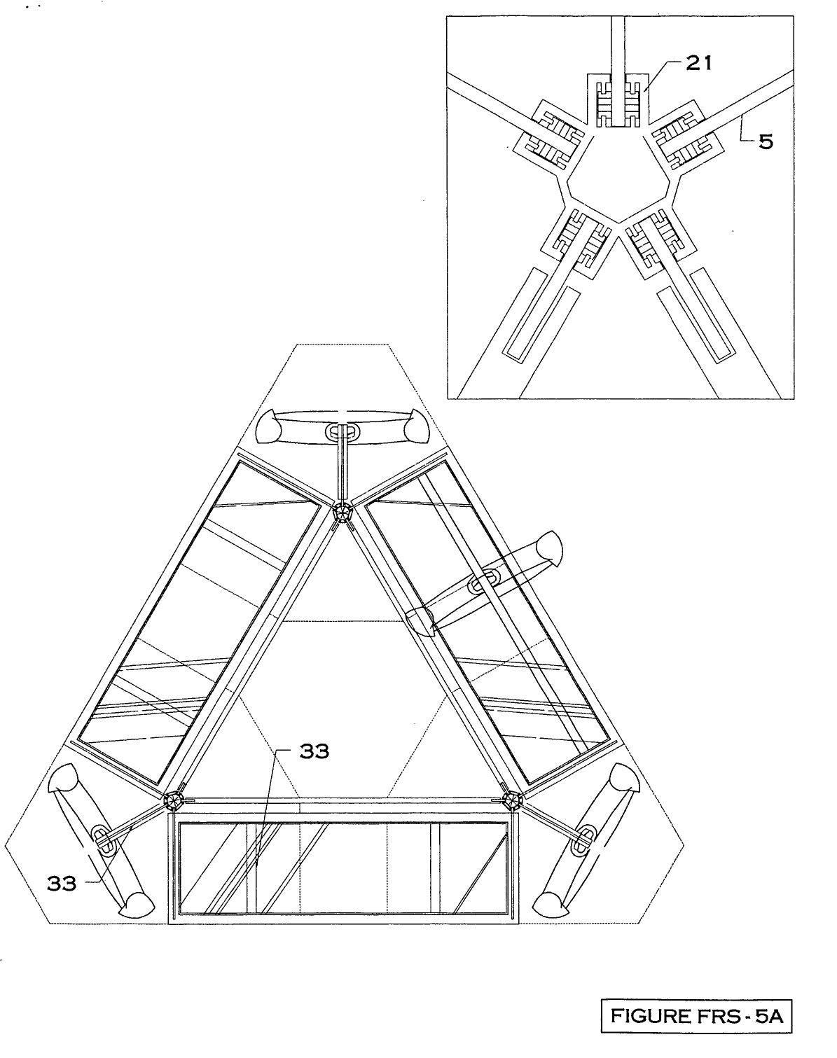

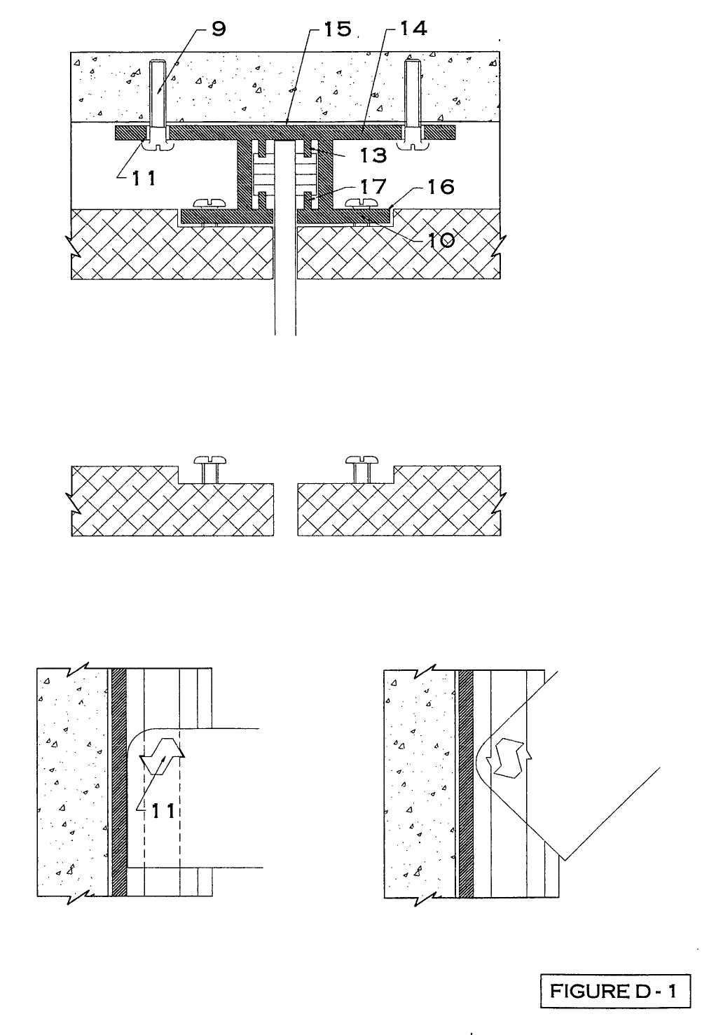

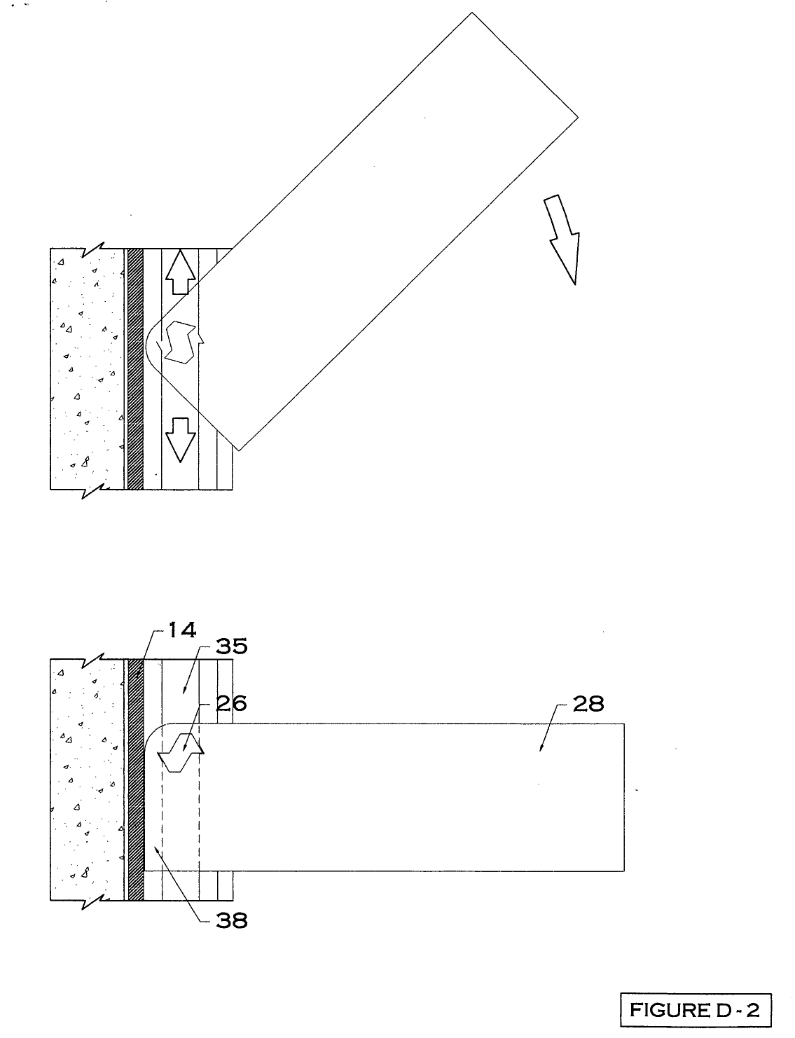

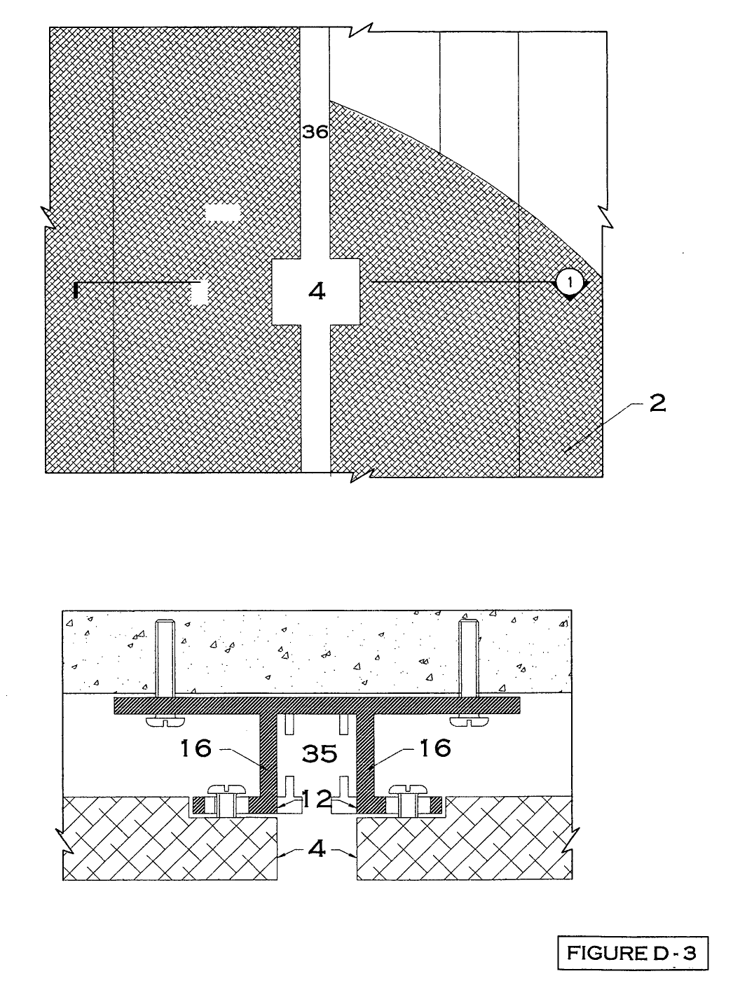

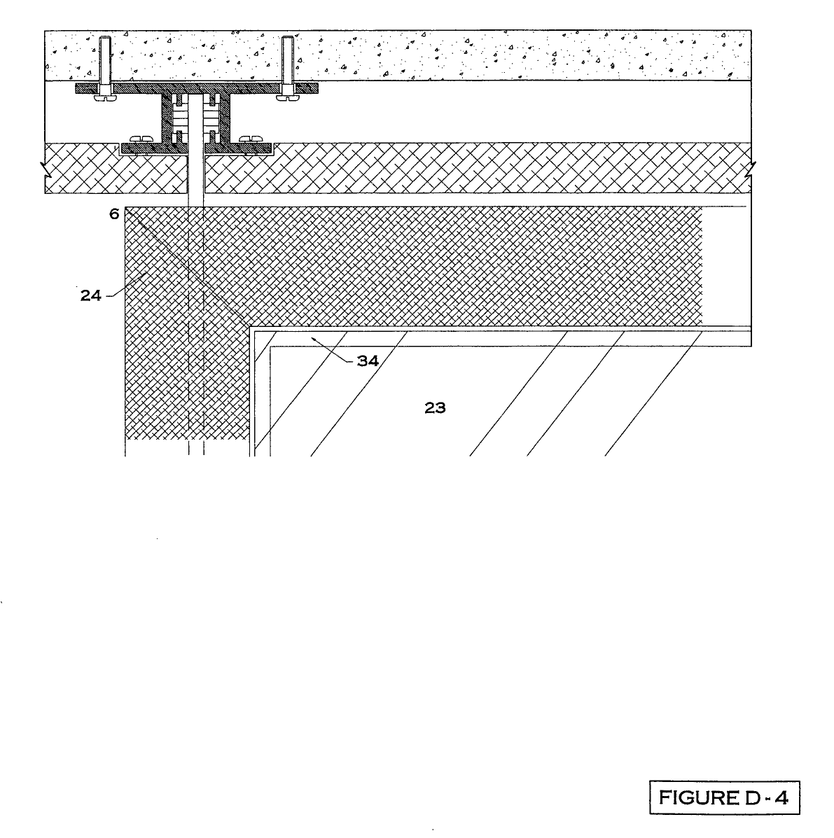

Free-standing extrusions may be combined in a variety of ways to create display installations. Examples of these are depicted in Figs. FRS-1-5A. Extrusions are supported by base units such as those depicted in Fig. FRS-1 (31) and Fig. FRS-5 (32). Displays may include front hang bars 33 (Fig. FRS-1-5A), shelving, paneling, shelving with hang bars, or any of the fixtures described above. Figs. FRS-1-3 depict an installation using two free-standing quad extrusions. Fig. FRS-4 depicts an installation using three free-standing quad units, and FIGS. 5-5A depict an installation using three tri-extrusions.

Although the present invention has been described by way of a preferred embodiment and certain variations and modifications, other variations and modifications can also be used, the invention being defined by the following claims.

What is claimed is:

1. A standard comprising:
at least one longitudinal channel comprising a rear wall, two parallel spaced side walls connected to and extending forwardly and orthogonally from said rear wall, said channel having an opening between said side walls formed along its length and at the forward region thereof, said opening being defined by the inward extensions of a pair of front flanges that extend towards each other from the forward edge of said side walls in a plane parallel to said rear wall of said channel, and two pairs of fins extending into the interior of said longitudinal channel orthogonally from said rear wall of said channel and orthogonally from said inward extensions of said front flanges.

2. The standard of claim 1 wherein said front flanges comprise outward extensions that project from said side walls away from said channel in a plane parallel to said rear wall.

3. The standard of claim 2 wherein said front flanges contain one or more keyholes for insertion of a screw.

4. The standard of claim 1 wherein said rear wall extends outwardly from said side walls to form a pair of rear flanges orthogonal to said side walls.

5. The standard of claim 4 wherein said rear flanges contain holes for insertion of screws or other fastening means for mounting said standard to a wall.

6. The standard of claim 1 wherein said opening is widened at one or more points along the front of said standard by the presence of one or more holes in the interior extensions of said front flanges along the face of said standard for insertion of shelving brackets into said standard.

7. The standard of claim 2 comprised of two of said channels wherein said two channels are connected such that said openings of said two channels face away from one another.

8. The standard of claim 2 comprised of four of said channels connected together wherein said opening of each of said channels faces 90° away from the adjacent channels and said channels are connected such that said rear walls of said channels face one another and said openings face outwardly.

9. The standard of claim 2 comprised of five of said channels connected together such that each of said openings faces outward away from said opening of each of the other of said five channels.

10. Support system for shelving comprising:
two or more of the standards of claim 1 and;
one or more brackets comprising:
a first end that fits into said longitudinal opening and is secured within said longitudinal channel;
an upper supporting surface along at least a portion of its length;
and a means for securing said bracket whereby said means for securing allows the bracket to be pivoted and moved longitudinally within channel when in a non-load-bearing position and secured at any height within said channel when in a load-bearing position.

11. A free-standing or wall-mounted support system for shelving comprising:
two or more of the standards of claim 3 and;
one or more brackets comprising:
a first end that fits into said longitudinal opening and is secured within said longitudinal channel;
an upper supporting surface along at least a portion of its length;
and a means for securing said bracket whereby said means for securing allows the bracket to be pivoted and moved longitudinally within channel when in a non-load-bearing position and secured at any height within said channel when in a load-bearing position.

12. A free-standing support system for shelving comprising:
two or more of the standards of claim 7, 8, or 9 affixed to supportive bases and;
one or more brackets comprising:
a first end that fits into said longitudinal opening and is secured within said longitudinal channel;
an upper supporting surface along at least a portion of its length;
and a means for securing said bracket whereby said means for securing allows the bracket to be pivoted and moved longitudinally within channel when in a non-load-bearing position and secured at any height within said channel when in a load-bearing position.

13. The support system of claim 11 or 12 wherein said means for securing said bracket is a machined hex pin that engages into said two pairs of fins that extend into the interior of said channel.

14. Wall covering system comprising:
the support system defined by claim 11 further comprising at least one additional standard for a total of at least two standards;
and at least one panel attached along its longitudinal edges to, and between said front flanges of said standards.

15. The wall covering system defined in claim 14 wherein the longitudinal edges of said panels are thinner in depth than the rest of the panel and said thinner edges contain screws such that when said panels are attached to said front flanges said thinner edges extend laterally from the site of attachment to said front flanges over said inward extensions of said front flanges to abut said brackets, covering said inward extensions of said front flanges, and leaving said opening exposed.

16. The wall covering system defined in claim 15 further comprising end panels wherein said end panels comprise thicker longitudinal edges and wherein said end panels are attached to said front flanges of said standards at the end of a display to wrap around and conceal from view the edges of said standards.

17. The system defined by claim 15 wherein said panels are covered with a surface treatment or finished with materials such as veneer, laminate, plaster, or wallpaper.

18. The system defined by claim 15 wherein low-voltage electrical light tape is affixed to said panels.

19. The system defined by claim 15 wherein acetates or transparencies are affixed to said one or more panels to facilitate display of any image.

20. The system defined by claim 15 wherein panels are magnetic and decorated with magnet-backed removable prints.

21. The system defined by claim 15 wherein panels are velcro-faced or puck wall panels.

22. Modular shelving comprised of the supporting structure defined in claim 15 and; additional fixtures that rest on said brackets are attached to said brackets or comprise a built-in hollow channel and pin-locking means to slide over and cover said brackets.

23. The modular shelving of claim 22 wherein said fixtures are extruded polyvinyl chloride or other shelving structures that allow for insert options in the center of the frame including but not limited to stainless materials, leather inserts, and glass.

24. The modular shelving defined in claim 22 wherein said fixtures include shelves, hang bars, drawers, cabinets, shelves containing hanging racks, and/or other standard fixtures.
